(19) United States
(12) Patent Application Publication
(10) Pub. No.: US 2008/0217256 A1
(43) Pub. Date: Sep. 11, 2008

(54) Water Purification Plant

(75) Inventor: Michael Everton, Victoria (AU)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: WODAPURE PTY. LTD., TOORAK (AU)

(21) Appl. No.: 10/585,795

(22) PCT Filed: Jan. 17, 2005
(86) PCT No.: PCT/AU05/00049

§ 371 Date: May 16, 2007

(30) Foreign Application Priority Data
Jan. 15, 2004 (AU) 2004900186

(51) Int. Cl. C02F 1/68; B01D 21/30

(52) U.S. Cl. 210/741; 210/232; 210/137; 210/756; 210/807; 210/202

(57) ABSTRACT

A water purification unit is described having a number of sub-assemblies arranged in a more or less modular arrangement including a compression unit and a sterilization unit. The water purification unit is operated at a throughput rate less than the maximum throughput rate so that the flow rate of raw water being treated by the water purification unit is as at a predetermined in order to reduce the effects of blinding of the filter. The sterilization rate is calculated in accordance with the predetermined first flow rate so that the dosage rate of sterilization agent remains substantially constant thereby avoiding fluctuations in the dosage rate so that the treated water has an amount of sterilizing agent within a predetermined range.

The present invention relates generally to water cleaning treatment such as water purification to produce clean water for a variety of purposes. More particularly the present invention relates to the use of various sterilizing and/or filter materials such as diatomaceous earth to filter unwanted materials, substances, biological matter or the like from water to clean the water such as for example, to produce clean water that is useful for use domestically and commercially, particularly for use as potable or drinking water. Even more particularly the present invention relates to a compact self contained versatile water purification and/or sterilizing unit for purifying water by passing raw or contaminated water through a combination of one or more sterilizing agents and one or more filter materials in which the purification unit is easier to operate, particularly by untrained operatives or other personnel, than existing purification units, whilst still producing acceptable quality drinking water. The present invention finds particular application as a self contained portable water purification unit that is easy to condition, ripen, prepare, run and/or operate and that provides quality drinking water by using a combination of diatomaceous earth filters and sterilizing agents in the form of chlorine or a chlorine containing compound to remove unwanted materials from water including removing particulate material and/or biological matter such as for example Giardia and Cryptosporidium. Additionally, owing to the unit being self contained and readily portable, the unit can be quickly and easily transported to disaster sites, such as areas that were subjected to the devastating effects of the Tsunami disaster, and quickly commissioned and operated by untrained local personnel to provide a viable water supply of clean water from the existing contaminated water supply, ground water or other water present at the disaster site or the like.

Although the present invention will be described with particular reference to one embodiment of the present invention it is to be noted that the scope of the present invention is not limited to the described embodiment but rather the present invention is more extensive in scope to include other forms, layouts and arrangements of the unit and components therefore, other uses of the unit and the use of different materials, agents, reagents or the like in the unit.

One problem of existing water purification plants is that they are fixed in place which makes it difficult if not impossible to readily transport them, particularly to quickly dismantle them and transport them to remote sites before reassembly prior to use. Also, owing to their bulk and structure, it is not possible to readily transport such units to areas suffering natural disasters such as earthquakes, land slides, tidal waves, or the like because of the lack of adequate roads and other infra structure. Many of the same disadvantages are possessed by many so called portable purification units which are in reality not transportable and are not easy to reassemble and use.

Another problem associated with existing units are that they are difficult to use and overly complex in their structure, assembly, operation and use, not to mention their maintenance and repair. A further problem of existing water purification plants is that the quality of water produced by such plants is not acceptable. Another problem of existing mobile water purification plants is that they are heavy, cumbersome and difficult to transport. Another problem of existing purification units is that it is difficult and time consuming to add or load chemicals to the unit and/or to condition or ripen the unit prior to operating the unit to produce acceptable quality drinking water. A further problem is that such units cannot be maintained or repaired or the filter system replaced or replenished whilst the units are in operation and/or whilst pumping water through the units. Another problem of existing units is that they are not versatile or flexible in their use and/or are not provided with removable components which can be quickly and easily replaced for repair and/or maintenance since such units do not have a modular construction.

One problem associated with existing water purification units is that almost all of the components, particularly the major components, are dedicated components in that such components have only one use and purpose which is to be used with the purification unit, and accordingly, the components cannot be used in situations or environments other than in the purification unit. This dedicated use of the various components, restricts the usefulness of the purification unit and the various components of the purification unit. If the various components could be used away from the purification unit, such as for example, independently of the purification unit for other purposes or by themselves in other applications, such components would be more useful and the use of the purification unit and/or its components would be more versatile and flexible, since the unit and/or the components could be used in a wider variety of different applications, and not necessarily restricted to water purification alone. This is particularly so in disaster areas where there are many different requirements to restore services and infrastructure. Thus, there is a need to re-evaluate and/or redesign water purification units to make them more versatile and useful in other applications. Surprisingly, the present inventor has been able to address at least some of the shortcomings of existing water purification units by providing an improved unit having at least one, and preferably, more than one detachable components or sub-assemblies of components that have uses other than solely as part of a water purification unit, such as for example, by forming self contained units capable of independent operation. The inventor has been able to do this by providing a modular structure or a system of modular units interconnected together to form the purification unit.

Accordingly, the present invention sets out to provide a modular self contained portable minimal maintenance easily operated water purification plant providing quality drinking water that has at least one or more components that is or are separately removable from the main unit and/or are capable of operation more or less independently away from the purification unit.

Another problem associated with previous purification units related to the operation of the sterilizing section of such units. Previously, purification units were operated at or near to their maximum pressure and/or throughput or flow rate. The sterilizing rate of the sterilizer section of the purification unit was designed in accordance with this maximum flow rate or pressure so that sufficient sterilizing agent, such as for example, chlorine was made available to sterilize the water at this rate. During operation of the purification unit, the filters, particularly filters using fine particulate material absorbing the very small sized suspended solids and the like had a tendency to block, clog or blind, the filter. This in turn reduced the amount of raw water that could be passed through the unit, sometimes significantly, if the filter became excessively blocked. Thus, the flow rate and/or throughput was reduced. In extreme cases, the flow rate could drop to less than a quarter of the normal maximum flow rate. However, the dosage rate of chlorine added as a sterilizing agent to the raw water continued at a rate commensurate with the maximum rate since the dosage rate of sterilizing agent was calculated on the basis of the maximum throughput flow rate. This resulted in excessive chlorine being introduced into the cleaned water. As excessive amounts of chlorine are toxic to humans and other animals, there was a chance that the cleaned water was toxic, poisonous or the like which produced health problems in consumers of the treated water. This was clearly unsatisfactory. This problem or shortcoming of previously available purification units was usually addressed by having an operator continuously monitoring the amount of chlorine in the water to ensure the amount of chlorine being added was within specification. The requirement to have an operator attend the unit at all times or at least regularly was a waste of man power resources, particularly in disaster areas where time and effort were paramount and man power was short. Thus, there is a need to have better control over the flow rate and sterilizing dosage rate within the water purification plants to better match the dosage rate of the sterilizing agent to the flow rate of the water through the unit to ensure the required amount of sterilizing agent is used independent of the extent of blockage or clogging of the filter unit and/or of the actual flow rate rather than the dosage rate being based on the maximum flow rate.

Thus, the present invention sets out to provide a water purification unit having a control means or regulator for more accurately matching the dosage rate of the sterilizing agent to the throughput flow rate of water actually passing through the purification unit thereby maintaining the dosage rate within predetermined ranges irrespective of the extent of blockage, clogging or blinding of the filtering system of the purification unit. In one embodiment this was achieved by reducing the throughput to a known flow rate that could be accommodated by the filter system even when partially or significantly blocked or clogged so that the same throughput is maintained at all times and matching the dosage rate of sterilizing agent to this controlled reduced flow rate of water.

It is to be noted that not all embodiments of the present invention satisfy all of the aims of the present invention nor do all embodiments address or overcome all of the problems of previous purification units. So long as each embodiment attends to address or satisfies at least one shortcoming of previous units, such embodiments fall within the scope of the present invention.

According to one aspect of the present invention there is provided a transportable water purification unit comprising a first subassembly which is essentially a pumping unit capable of pumping water substantially to, through and from the unit and a second subassembly which is essentially a filtering unit capable of filtering at least biological matter and/or particulate matter from the water by passage of the water through the filtering unit so as to produce substantially cleaner water wherein at least the first sub-assembly and/or the pumping unit is demountable from the purification unit and is capable of operation independently of operation of the purification unit.

According to another aspect of the present invention, there is provided a transportable water purification unit comprising a first sub-assembly which is essentially a pump capable of pumping water through the purification unit at a first flow rate, and

a second sub-assembly which is essentially a sterilizing unit capable of introducing a dosage rate or amount of sterilizing agent to the water being treated by the water purification unit at a second flow rate, and

a filtering system for filtering contaminants from the water being treated

wherein the purification unit is provided with a control means for controlling the first flow rate to a predetermined range of flow rate, said predetermined range being independent of the extent of blockage or clogging of the filter system so that the dosage rate of the second flow rate is within a preselected amount thereby substantially reducing, or eliminating fluctuations in the dosage rate of the sterilizing agent.

According to another aspect of the invention, there is provided a method of operating a transportable water purification unit characterized in that a first sub-assembly which is essentially a pumping unit capable of pumping water through the purification unit is operated to produce a first flow rate of water through the purification unit at a first flow rate, in that a second sub-assembly which is essentially a sterilizing unit capable of introducing a dosage rate or amount of sterilizing agent to the water being treated by the water purification unit is operated at a second flow rate, in that the first flow rate is regulated or controlled to a predetermined value by a control means for controlling the first flow rate irrespective of the state of a filter system wherein the control means is operated to produce or regulate the first flow rate and the second flow rate is determined in accordance with the first flow rate thereby substantially reducing or eliminating fluctuations in the dosage rate of the sterilizing agent in the water being treated by the purification unit.

Typically, the purification unit of the present invention comprises a third sub-assembly which is a sterilizing unit. More typically, the sterilizing unit is an adjustable dosage sterilizing unit in which the dosage rate can be adjusted to be constant.

Typically, the pumping sub-assembly includes a motor and a pump, more typically a diesel motor and pump. Even more typically, there is a single motor and pump providing both the first and second flow rates.

Typically, the control means includes a control member or regulator. More typically, the control member is a valve, preferably a one way valve. Even more typically, the valve is a self-sustaining pressure valve or self-regulating pressure valve. Even more typically, the valve is an automatic control valve designed to sustain a minimum upstream backpressure. In one form, the valve is a pilot controlled, hydraulically operated, diaphragm actuated globe valve in either an oblique or angle pattern design. Valve differential pressure powers the diaphragm actuator open or closed.

Typically, the valve is located downstream of the filtering unit, more typically downstream of the sterilizing unit, and more typically, at or near to the clean water discharge outlet for controlling or regulating the flow of cleaned or treated water from the purification unit. More typically, the pressure at which the self sustaining pressure valve is operated or set is sensed by a suitable sensor located in the first flow path, preferably at the discharge or exit of the pump producing the first flow of water to be treated.

Typically, the pressure sustaining valve is set to a pressure and/or flow rate less than the maximum pressure and flow rate of the pump, more typically to a generally mid range value of flow rate lower, preferably significantly lower, than the maximum pressure or flow rate. More typically, the pressure or flow rate is generally about half of the maximum pressure or flow rate.

Typically, the pressure varies from about 100 to 400 kpa, preferably from about 150 to 300 kpa, even more preferably from about 200 to 300 kpa, even more preferably from about 240 to 260 kpa, and more preferably at about 250 kpa.

Typically, the flow rate varies from about 4,000 1/hr to about 10,000 1/hr, preferably from about 5,000 1/hr to 9,000 1/hr, more preferably about 6,000 1/hr.

Typically, the higher the pressure the lower the flow rate of the first flow such as for example, about 5,000 1/hr at 300 kpa, and the lower the pressure the higher the flow rate of the first flow such as for example, at 150 kpa pressure the flow rate is between about 8,000 and 9,000 1/hr.

One form of the water purification plant of the present invention has been designed to treat water that is polluted with suspended solids and/or biological matter such as bacteria or the like to provide potable water particularly in the field or whilst travelling or the like. The unit of the present invention is primarily designed to provide potable water in situations such as war, natural disasters, fire, adverse weather conditions, in refuges, refugee camps, or the like where poor quality or undrinkable water is available but is unusable so that by using the purification unit cleaner water can be produced that is of an acceptable standard of cleanliness for drinking or for other useful purposes both domestically and commercially, such as for example, free of tetanus contamination or materials causing tetanus or the like.

One form of the purification plant of the present invention which is referred to as the DE6000 water purification plant purifies water at a flow rate of 1,500 GPH. It will filter out solid particles to less than 1 micron and therefore will remove Giardia and Cryptosporidium from the water down to levels greater than 3 log which is a 1000 fold reduction. Giardia and Cryptospordium are bacteria present in water that is unfit to drink and are responsible for causing ill health. In addition, a sterilizing agent is added to the filtered water. One example of the sterilizing agent is chlorine. As well as using chlorine to sterilize/disinfect the filtered water other disinfecting/sterilizing agents can be used, such as chemical agents, ultra violet radiation, or similar. Another example of a sterilizing agent is a silver and/or copper compound combination. It is to be noted that any combination of suitable sterilizing agents or means can be used as desired.

Typically, the purification unit is provided with a pretreatment sub-assembly for pretreating the water either prior to filtering the water in the filtering unit or prior to sterilizing the water in the sterilizing unit. More typically, the pretreatment step includes removing and/or neutralizing one or more of the contaminants in the water.

The present invention will now be described by way of example with reference to one form of the purification unit as shown in the accompanying drawings in which:

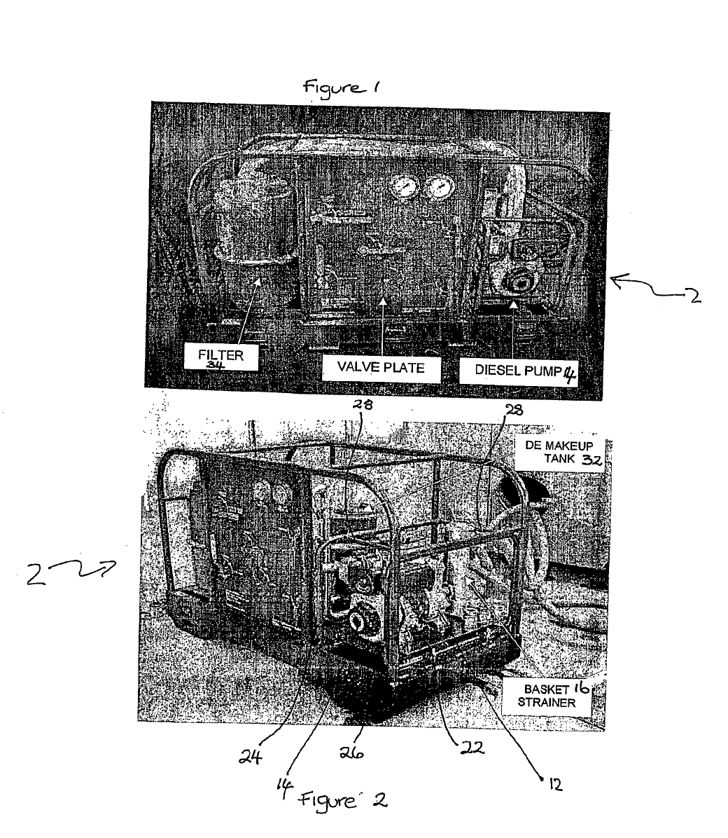

FIG. 1 is a front view of one form of the water purification plant of the present invention showing the arrangement of some of the components.

FIG. 2 is a front and one end view of the water purification plant of FIG. 1.

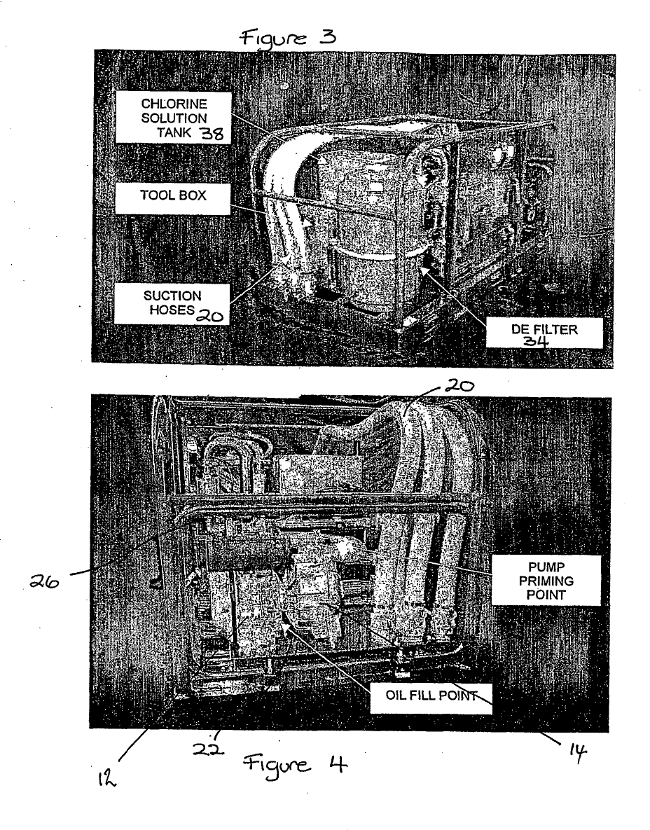

FIG. 3 is a front and other end view of the water purification plant of FIG. 1.

FIG. 4 is the other end view of the water purification plant of the present invention.

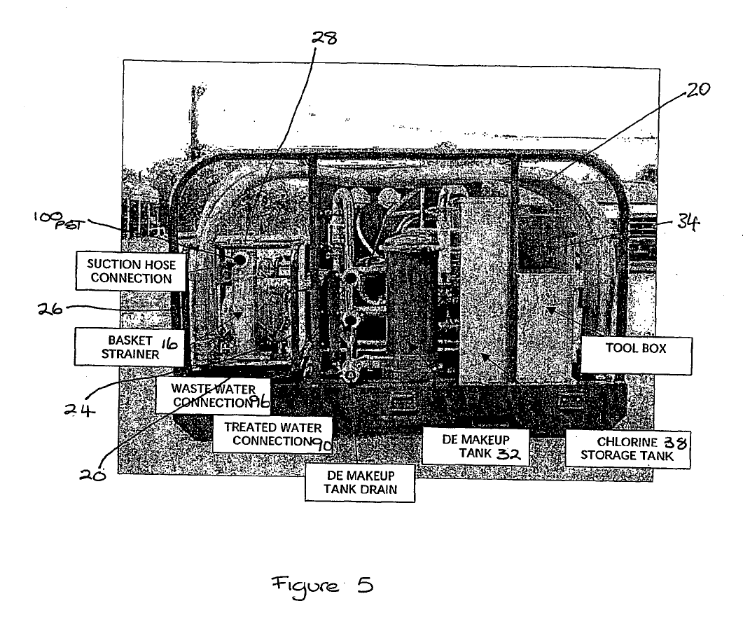

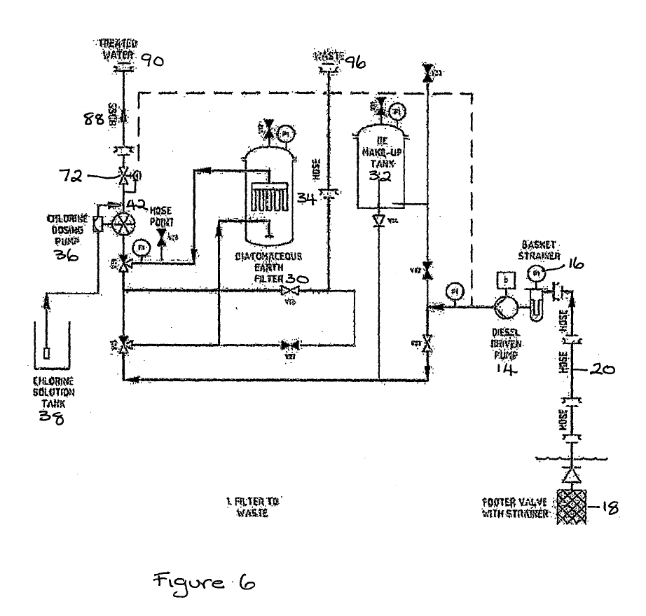

FIG. 5 is a rear view of the water purification plant of FIG. 1.

FIG. 6 is a schematic plan view showing the relationship of the various major components of one form of the purification unit.

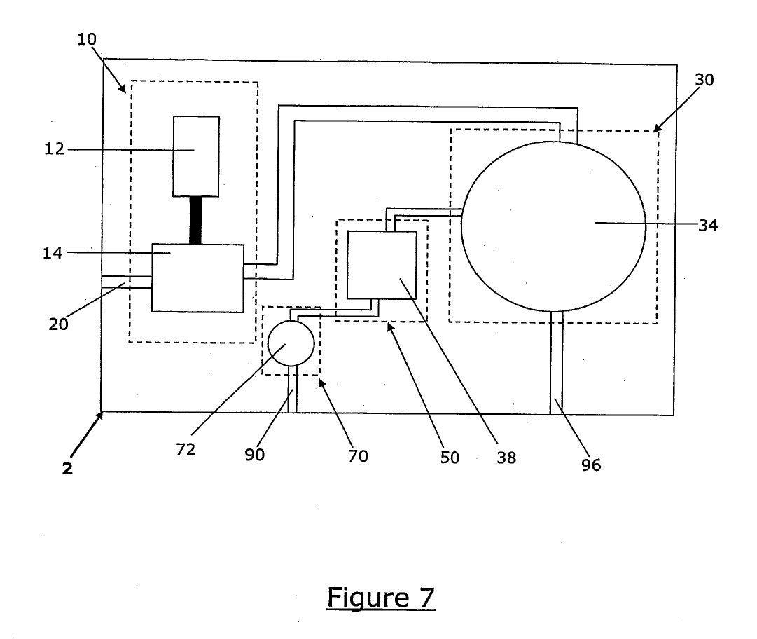

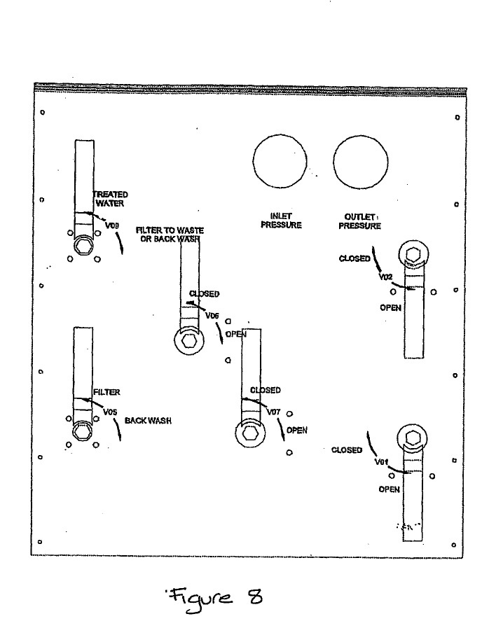

FIG. 7 is a flow chart showing the interconnection of the various components of the water purification plant of FIG. 1.

FIG. 8 is a schematic view of one form of a control panel of the water purification plant of FIG. 1.

One form of a purification unit, generally denoted as 2, in accordance with the present invention is known as the DE6000 model made under the authority of the present applicants.

The DE6000 is a self-contained unit comprising essentially a number of main sub-units or sub-assemblies, which are a combined motor and pump unit 10 comprising a motor 12, preferably a diesel motor, and a pump 14, a diatomaceous earth (DE) filter unit 30, a sterilizing unit 50 and a pressure sustaining valve assembly 70. Other sub-assemblies can be provided as required, including modifications of the sub-assemblies, all of which are more or less modular.

In the filler unit 30, diatomaceous earth or DE as it is commonly referred to, which is used as the main filter medium, is a fine crystalline silica powder derived from fossilized marine animals that has the capability to absorb small sized particles down to less than about 1 micron. The DE filter unit 30 will be described in more detail later in the specification.

The diesel driven pump sub-assembly 10 is formed as a separate module that is self contained within itself and is capable of being removable as an integral unit from the purification unit 2 so as to be able to be used by itself as a water transfer pump rated at about 6000 1/hr or 12,000 GPH (200 GPM). When the pump assembly 10 is removed from the water purification unit, it can be operated as an independent stand alone pumping unit. Typical applications for this independent operation include its use as a water pump to fight bush fires, drain flooded areas or the like. It can also be used for fire fighting when fitted with modified nozzles. The pump sub-assembly also includes a basket strainer 16 that will remove particulates larger than 1/16″ (1.6 mm) from the stream of contaminated water being introduced into the unit to prevent such relatively large sizes particles from actually entering the pump 14 thereby reducing the chance of damage to the pump 14. Any form of suitable strainer can be used.

The unit 10 is also provided with a suction line for introducing water into the purification unit 2 from the raw water source. The suction line comprises a check valve/strainer 18 or footer valve with strainer with support ring that is placed in the raw water source. To this are connected three suction hoses 20 and these are then connected to the basket strainer 16. Thus, raw water can be readily introduced into the purification unit 2 when operating as a purification unit or if the pump 14 is being used as a pump to transfer raw water, such as for example, pumping a building after a flood, tidal wave or other to remove excess water. In this mode, the flow path of rain water need not necessarily pass through the filter sub-assembly 30 and/or sterilizing unit 50.

It is to be noted that the pump sub-assembly 10 is self supporting either within the purification unit 2 or when used as a stand alone assembly or in both forms. In one embodiment, the pump sub-assembly is provided with its own skid plate 22 or skids as the supporting structure for use when the pump unit 10 is used separately away from the purification unit 2. One form of the skids includes a pair of spaced apart skid bars or similar located at or towards either side of the sub-assembly. In another embodiment the self supporting structure also includes handles for use in moving the sub-assembly. In still further examples, the supports comprise a pair of metal tubing loops 24, 26 located on either side of the sub-assembly 10 having one or more cross members 28 to provide structural rigidity for the assembly when removed from the unit 2. In other embodiments, skid plate 22 is provided with feet for supporting sub-assembly 2 thereupon. Any suitable modular form of pump sub-assembly 10 can be used.

In another embodiment, the sub-assembly 10 is connected to water purification unit 2 by suitable couplings for the suction hoses or other inlets such as for example, quick connect couplings, quick release fasteners or the like. One example of the connectors are cam lock fittings or similar.

The sub-assembly 10 is releasably connected to unit 2 by quick release fasteners, such as wing nuts or the like. It is to be noted that sub-assembly 10 can be detachably mounted to the remainder of unit 2 by any suitable or desirable means. Further, it is to be noted that the inlets and outlets of sub-assembly 10 can be connected to the remainder of unit 2 such as the foot valve 18 or inlet to the filter unit 30 or the like, in any suitable manner allowing the sub-assembly to be removed and/or reconnected quickly and easily.

The DE filter unit 30 comprises of DE makeup tank 32, a DE filter 34, a chlorine dosing pump 36, a chlorine storage tank 38, valves and pipework for operation of the system as shown schematically in FIGS. 6 and 7. All of these components are fitted to the main frame which is provided with a carrying handle and a skid plate or pair of skids or the like and one or more transverse braces for providing structural strength to unit 2.

Additionally, it is to be noted that the components of the filter unit 30 and sterilizing unit 50 can be located as a single modular unit or the two sub-assemblies can be separate sub-assemblies.

The purification unit is provided with a control means for controlling or regulating the flow rate of water through the purification unit or throughput. In one embodiment, the control means is a control valve, typically a self sustaining pressure valve or self regulating pressure valve 72. The valve can be of any suitable type for maintaining the flow rate at a preset level. The purpose of the regulating valve is to reduce the flow rate of water being pumped through the purification unit to an amount which is less, sometimes significantly less than the maximum flow rate. Typically, the flow rate is generally about half of the maximum flow rate. The regulator restricts the flow rate to about half the maximum rate so that this rate can be maintained even if the filter system, typically the DE filter system 30 should block, clog, blind or the like to reduce the flow rate. It is important that a more or less consistent flow rate be maintained so that the dosage rate of sterilizing agent can be selected to provide a more or less constant flow rate of sterilizing agent being introduced into the treated water so as to avoid fluctuations in the amount of sterilizing agent being introduced. As the flow rate of water through the unit and dosage rate are operated independently although being interrelated in some embodiments, it is important that the main flow rate be regulated to be compatible with the dosage rate or vice versa. Further, a pressure sensor or other suitable sensor is provided at the discharge outlet or exit of the pump 14. This pressure sensor is connected to the pressure sustaining valve 72 in order to regulate and/or control the back pressure in the first flow path so that the throughput or first flow is about half of the maximum throughput of the pump.

### Specifications of the DE6000 Unit

Dry weight: about 380 kg; (840 lb)
Crated weight: about 428 kg (945 lbs)
Operational Temp range: about 0° C. to 60° C. (32° F. to 110° F.)
Dimensions uncrated: about 900 mm wide (35.5″ wide), 1800 mm long (70.9″ long), 1060 nm high (41.7″ high).

### Capabilities

Flowrate: 6,000 L/hour (1500 GPH) when operating as a purification unit when the pressure regulator valve is adjusted in accordance with the present invention.
Removes turbidity and suspended solids down to particle sizes of less than 1 micron.
Residual disinfection: achieved by dosing Calcium hypochlorite at up to 8 ppm through the unit.

### Features

A modular system for easy removal of pump unit.
A simple 2-stage DE makeup system without complicated pilot lines that are susceptible to blockages.
Simple chlorine dosing system.
Easy to operate by untrained operators or personnel.
Self controlling constant filtration rate.
   Main module
Skid frame with protective bars
DE makeup tank
DE filter
Chlorine tank
Chlorine dosing pump
Hoses

Suction hose 10′ (3 off)

Treated water hose layflat 50′

Waste water hose layflat 50′

Pump module
Frame
Diesel driven pump 200 GPM
Basket Strainer
Self supporting skid or skids to support the pump sub-assembly when being used independently.

### Description of Operation

The following is a general description of the operation of the DE6000 Water Purification Plant (WPP). Detailed operation of the unit in purifying water is described later in this specification.

Diatomaceous earth (DE) filtration is an effective means of filtering water to remove particulates down to a very small size. By using the specified diatomaceous earth substantial removal of particulates to less than 1 micron is achievable.

In the DE6000 Water Purification Plant (WPP) a quantity of DE is placed in the DE makeup tank 32 while the system is running and is transferred onto the septum (cloth covered frame onto which the DE is deposited) of the DE filter 34 where it builds up as a layer, covering substantially all of the entire area of the filter.

The DE6000 WPP uses a layer of fine DE as the main filtering media and a thinner layer of coarse DE to extend filter life.

After the DE has deposited onto the filter initially the filter needs to ripen. Ripening of a filter means to run it for a period of time, usually 5-10 mins, to let the DE settle and to allow some of the particulates to build up on the DE which increases the extent and efficiency of the filtration of the water being treated.

During the ripening period the chlorine solution can be prepared. Filling the chlorine tank 38 with water from the hose on the unit and adding the chlorine powder achieves the production of a chlorine solution. Thorough mixing of the chlorine powder with the water ensures that it is fully dissolved. This is one example of the sterilising agent useful in the present invention. Other sterilising aspects can also be used.

After the filter has ripened the DE6000 WPP can be changed from a first position which is discharge to waste water to a second position which is discharge to the treated water storage 90. When this happens the inline dosing pump automatically doses the chlorine into the water to sterilize/disinfect the water at the required dosage rate which has been selected in accordance with the flow rate of pump 14.

The DE6000 WPP is a constant rate filter running at about 35 to 38 psi (240-260 kPa). When the inlet pressure gauge starts to rise above this level the filter is starting to load up and will need to be backwashed and then recharged with DE again. By running at less than maximum pressure, the operational life of the purification unit between backwashes to clean the filter is extended by the unit being able to tolerate a reduction in flow through the filter caused by blockage of the filter.

### Priming Pump and Suction Hoses

Remove the lid from the basket strainer 16 and fill with water. The collapsible bucket can be used if another source is not available. The suction hoses should be full from the foot valve 18 all the way to the strainer 16.

### Operation

### Starting the Pump

Set the valves as follows:

| Valve | | |
|---|---|---|
| No | Valve Description | Valve Position |
| V01 | System inlet valve | Open |
| V02 | DE makeup tank inlet | Close |
| V03 | DE makeup tank drain | Close |
| V04 | DE makeup tank check valve | No control |
| V05 | Filter/Backwash inlet valve | Filter |
| V06 | Filter to waste valve | Open |
| V07 | Backwash to waste valve | Close |
| V08 | Hose point | Close |
| V09 | Filter/Backwash inlet valve | Filter to waste |
| V10 | Constant flow valve | No control |
| V11 | DE tank air relief valve | Closed |
| V12 | Filter air relief valve | Closed |

After the pump has been primed the motor is started.

Open the fuel shut-off valve on the left hand side of the engine by turning the handle downward. Move the throttle to about half way.

Press the decompression lever on the top of the pump until it stays down. If it does not stay down pull the crank cord out a little way until it does. Pull the crank cord firmly to start the engine. As there is no electricity supply provided on the unit, there is no batter or similar storage unit. Therefore, the diesel motor is required to be started by hand cranking using a suitable system.

Once the engine has been started the water should be flowing through the system and discharging from the waste water hose 88.

Open the air release valve on top of the filter V12 until water runs out. Close the valve.

Provided with the unit are 2 bags of fine DE and 1 bag of coarse DE. The 2 bags of fine DE are used first.

To apply the DE to the filter 34 the DE makeup tank 32 needs to be filled with one bag of fine DE. Take the lid off the DE makeup tank 32 and empty a bag of DE powder into the tank. Wash off any DE on the lip of the tank and the lid as the DE can make the lid and clamp jam. Close the lid firmly. Open the DE makeup tank inlet valve V02 located on the front valve plate. This will transfer the DE onto the filter. Leave V02 open for about 2 minutes, close it and then open the DE makeup tank drain, V03, located at the base of the DE makeup tank. Drain about half the water out of the tank. Close the drain valve, take the lid off and put the second bag of DE into the DE makeup tank. Close the lid and open V02 to transfer the DE onto the filter.

Repeat the procedure for the third bag of DE.

Before closing V02 close V01 for about 30 seconds as this will flush the last of the DE from the makeup tank. Open V01 and close V02. The DE filter 34 is now loaded with a sufficient quantity of DE.

### Ripening Filter

Run to waste so that any discharge from unit 2 is discharged to waste through waste outlet 96 to for a period of time until the filter has ‘ripened’ and is ready to filter. This should take about 5 to 10 minutes. During this period make up the chlorine solution.

When the filter has ripened the chlorine solution can be prepared. Fill the chlorine tank 38 with clean water. Take a measured amount of chlorine powder (pre-measured bag) and add it to the water in the chlorine tank. Use the chlorine stirrer to make sure that all the chlorine powder has been dissolved.

### Priming the Chlorine Pump

Before going to the filtration step it is essential that the chlorine dosing pump 36 is primed and does not run dry. The chlorine pump only operates when in the filtration step as it is powered by the water from the filter.

Take the tube between the chlorine pump 36 and the chlorine tank 38 out of the chlorine tank. Use the hose to fill this tube and try to get all the air out. Insert the tube back into the chlorine tank. When the chlorine pump is operating in the filtration step the remaining amounts of air can be removed by moving the tube.

### Filtration

When the chlorine solution has been prepared the system can be used to produce filtered water.

Turn V09 slowly to “TREATED WATER”. Filtered water will now be diverted from the waste outlet 96 to the treated water outlet 90.

The chlorine solution will be mixed into the filtered water at introduction point 42 located upstream of pressure regulator valve 72.

Turn valve V06 to the closed position.

When the system has been set to filter to TREATED WATER the inlet pressure gauge will read about 240 kPa (35 psi).

The outlet pressure gauge will read approx 120 kPa (17 psi).

The pressure increases as the system is changed from FILTER TO WASTE to filter to TREATED WATER. This occurs as the constant flow control valve brings the system flow back to 1,500 gpm.

Filter run times will vary depending on the amount of contaminants in the water. The more contaminants that are in the raw water the shorter the run times are.

### Setting the Chlorine Dose

The dose rate of chlorine will depend on the storage requirements of the treated water. A residual of 0.5 ppm (parts per million) is usual. However, other dosage rates of up to about 12 ppm may be used if circumstances dictate. Typically, the amount of chlorine added to the water is from about 0.1 to 10 ppm, preferably from 0.5 to 6 ppm, more preferably about 2 ppm.

The dose rate is set from the following table and is the concentration of the chlorine as it leaves the filter. The residual value of chlorine in the treated water storage and in the reticulation system will depend on a number of factors and best evaluated at the very end of the system. It is desirable to have about 0.5 ppm at this point and all the other points will be above this.

| | | | | | | | | | | |
|---|---|---|---|---|---|---|---|---|---|---|
| Chlorine conc'n | Ppm | 1 | 2 | 3 | 4 | 5 | 6 | 7 | 8 | 9 |
| Stroke length | % | 11 | 23 | 34 | 46 | 57 | 68 | 80 | 91 | 103 |

Adjust the dose rate and tighten the locking nuts.

### Backwashing

Before backwashing make sure that the water produced from the backwash, which contains the waste diatomaceous earth (DE) and all the waste contaminants, is discharged into an appropriate container. This may be a berm or an open tank or portable dam.

V06 should already be shut. Change V09 to ‘BACKWASH’ and change V05 to “BACKWASH”. Open V07. These valve changes need to be done quickly.

Run until the water coming from the waste hose is clear of DE.

Reset the valves back to the start up position.

Open V06, close V07, change V05 to FILTER.

This completes the full cycle and the filter is ready to run again. Either stop the pump motor until water is again required or go back to the “PRECOAT APPLICATION” step. Ensure that all the valves are in the starting position again.

It is to be noted that in one mode of operation, the unit 2 can be operated as a sterilising unit only without 5 passing the raw water through the filter sub-assembly 30, whereas in another mode of operation, the sterilising unit can be by-passed so that the unit operates as a filtering unit only.

Glossary

| | |
|---|---|
| Calcium | disinfectant used in water treatment to maintain a |
| hypochlorite | residual concentration of chlorine in the storage tank. |
| DE | diatomaceous earth. |
| Ripening | ripening of a filter means to run it for a period of |
| | time, usually 5-10 mins, to let the DE settle down and to |
| | allow some of the particulates to build up on the DE |
| | which assists the filtration. |
| Septum | cloth covered frame onto which the DE is deposited in the |
| | filter. |
| Blind | when the filter starts to block up with solid particles. |
| Raw water | untreated water from the source, i.e. river, lake or |
| | pond. |
| Filtered | raw water after having passed through the DE filter |
| water | |
| Treated | raw water after having passed through the DE filter and |
| water | dosed with chlorine solution. |
| Triclover | easy to dismantle clamping system used in stainless steel |
| fittings | tubing |

Advantages of the water purification plant of the present invention include the following:

minimal maintenance,

easy to use,

minimal operational supervision of personnel operating the plant,

exceptional quality of drinking water produced from the plant in that 99.9% of Giardia and Cryptosporidium is removed from the treated water,

constant rate filtration,

modular design,—allows each sub-assembly to be isolated and if necessary replaced by a new sub-assembly thereby allowing the unit to be repaired quickly.

self powered no electrical power required,

disinfection system standard

highly portable.

It is to be understood that, if any prior art publication is referred to herein, such reference does not constitute an admission that the publication forms a part of the common general knowledge in the art, in Australia or any other country.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. Transportable water purification unit comprising a first sub-assembly which is essentially a pumping unit capable of pumping water substantially within the purification unit and a second sub-assembly which is essentially a filtering unit capable of filtering at least biological matter and/or particulate matter from the water by passage of the water through the filtering unit so as to produce substantially cleaner water characterized in that at least the first sub-assembly and/or the pumping unit is or are removable from or demountable from the purification unit so as to be capable of operation independently of operation of the purification unit.

2. A transportable water purification unit comprising a first sub-assembly which is essentially a pump capable of pumping water through the purification unit at a first flow rate, a second sub-assembly which is essentially a sterilizing unit capable of introducing a dosage rate or amount of a sterilizing agent to the water being treated by the water purification unit at a second flow rate, and a filtering system for filtering contaminants form the water being treated by passage through the purification unit characterized in that the purification unit further comprises a control means for controlling and/or regulating the first flow rate to a value within a predetermined range of flow rates in which said predetermined range is independent of the extent of blockage or clogging of the filter system reducing the flow rate of water through the purification unit so that the second flow rate or dosage rate of the sterilizing agent is maintained within a preselected amount in accordance with the regulated or controlled flow rate of water in the predetermined range thereby substantially reducing or eliminating fluctuations in the amount of sterilizing agent added to the water being treated by the purification unit.

3. A method of operating a transportable water purification unit characterized in that a first sub-assembly which is essentially a pumping unit capable of pumping water through the purification unit is operated to produce a first flow rate of water through the purification unit at a first flow rate, in that a second sub-assembly which is essentially a sterilizing unit capable of introducing a dosage rate or amount of sterilizing agent to the water being treated by the water purification unit is operated at a second flow rate, in that the first flow rate is regulated or controlled to a predetermined value by a control means for controlling the first flow rate irrespective of the state of a filter system wherein the control means is operated to produce or regulate the first flow rate and the second flow rate is determined in accordance with the first flow rate thereby substantially reducing or eliminating fluctuations in the dosage rate of the sterilizing agent in the water being treated by the purification unit.

4. A water purification unit or method according to any preceding claim in which the control means is a valve.

5. A water purification unit or method according to any preceding claim in which the valve is a self sustaining pressure valve or self regulating pressure valve for maintaining the first flow rate at a predetermined value substantially irrespective of the flow rate of water passing through the filtering system.

6. A water purification unit or method according to any preceding claim characterized in that the pressure sustaining valve is set to provide a first flow rate in the range from about a quarter to three quarters of the maximum throughput of water through the pump and/or purification unit.

7. A water purification unit or method according to any preceding claim characterized in that the first flow rate is generally about half the maximum flow rate of the water passing through the purification unit.

8. A water purification unit or method according to any preceding claim characterized in that the control means controls the first flow rate to about 600 to 800 gallons per hour.

9. A water purification unit or method according to any preceding claim characterized in that the maximum of the first flow rate is a flow rate of about 1500 gallons per hour.

10. A water purification unit or method according to any preceding claim characterized in that the filtering system removes solid particles to less than about 1 micron in size.

11. A water purification unit or method according to any preceding claim in which the filtering system of the purification unit removes Giardia and Cryptosporidium from the water being treated to values down to levels greater than 3 log or to less than 1000 of the value before treatment.

12. A water purification unit or method according to any preceding claim characterized in that the filtering unit is a diatomaceous earth filter unit.

13. A water purification unit or method according to any preceding claim characterized in that the sub-assembly comprising the pump is provided with a dedicated support structure for supporting the sub-assembly when removed from the water purification unit.

14. A water purification unit or method according to any preceding claim characterized in that the support is a skid plate or one or more skids upon which the pump sub-assembly is supported.

15. A water purification unit or method according to any preceding claim characterized in that filter material, preferable diatomaceous earth is added to the filtering system whilst operating the water purification unit to treat water.

16. A water purification unit or method according to any preceding claim characterized in that a sterilizing agent is chlorine or a chlorine containing material.

17. A water purification unit or method according to any preceding claim in which the chlorine sterilizing agent is chlorine powder or granulated calcium hypochloride or sodium hypochloride, preferably aqueous solution of sodium hypochloride.

18. A water purification unit or method according to any preceding claim characterized in that in which the regulator is located downstream of the sterilizing unit.

19. A water purification unit or method according to any preceding claim characterized in that the first flow is operated at a pressure of from about 100 kpa to about 400 kpa, preferably a range from about 150 kpa to 300 kpa, more preferably at a range of about 200 to 260 kpa, more preferably at a range of from about 220-260 kpa.

20. A water purification unit or method according to any preceding claim characterized in that there is a single pump for providing the first flow and the second flow, and the second flow is produced by the first flow.

21. A water purification unit according to any preceding claim characterized in that the first and second flow rates are independent of each other or are interrelated to each other or the valve of one is based on the valve of the other.

22. A transportable water purification unit substantially as herein described with reference to the accompanying drawings.

23. A method of operating a transportable water purification unit substantially as herein described with reference to the accompanying drawings.

24. A water purification unit or method according to any preceding claim substantially as herein described with reference to the accompanying drawings.
